(19) United States
(12) Patent Application Publication
(10) Pub. No.: US 2023/0021738 A1
(43) Pub. Date: Jan. 26, 2023

(54) FITNESS CONTROL SYSTEM AND SPINNING BICYCLE

(71) Applicant: Shenzhen Dongqu Technology Co., Ltd., Shenzhen (CN)

(72) Inventors: Congxu YANG, Shenzhen (CN); Hang ZHANG, Shenzhen (CN); Zaixing LI, Shenzhen (CN); Baojun WANG, Shenzhen (CN); Shenghong CAI, Shenzhen (CN); Weisheng HU, Shenzhen (CN); Guanting LIU, Shenzhen (CN); Guotai HE, Shenzhen (CN); Wulin CHEN, Shenzhen (CN); Meimiao FENG, Shenzhen (CN)

(21) Appl. No.: 17/515,659

(22) Filed: Nov. 1, 2021

(30) Foreign Application Priority Data
Jul. 26, 2021 (CN) 202110844233X

(51) Int. Cl. A63B 71/06; A63B 22/06; A63B 24/00

(52) U.S. Cl. CPC A63B 71/0622; A63B 22/0605; A63B 24/0087; A63B 24/0062; A63B 2024/0065; A63B 2225/50; A63B 2024/0096; A63B 2225/20; A63B 2071/0638

(57) ABSTRACT

Provided are a fitness control system and a spinning bicycle. The system includes: a central controlling unit for detecting change information of each parameter of the fitness equipment; and a terminal device for controlling, according to the change information of each parameter of the fitness equipment, a virtual character to simulate movement of a user who uses the fitness equipment in the target fitness scene, and for real-time detecting during a virtual character simulates movement of the user, the road condition information in the target fitness scene, and feeding back to the central controlling unit a control signal matching a set condition. The central controlling unit is also configured to control, according to the control signal, the fitness equipment to generate feedback matching the influence.

### CROSS-REFERENCE TO RELATED APPLICATION

The present disclosure claims priority of Chinese patent application with the filing number 202110844233X filed on Jul. 26, 2021 with the Chinese Patent Office, and entitled “Fitness Control System and Spinning Bicycle”, the contents of which are incorporated herein by reference in entirety.

### TECHNICAL FIELD

The present application relates to the field of fitness technology, and specifically, to a fitness control system and a spinning bicycle.

### BACKGROUND ART

With continuous development of science and technology and constant improvement of living standards, people's awareness to the health is gradually increasing, and more and more people love exercise.

Among many fitness programs, the spinning bicycle is one of the most popular fitness programs. The spinning bicycle is a fitness program with large amount of exercise, which improves cardiopulmonary function and also helps to lose weight, strengthen leg muscles, and improves overall physical fitness.

However, traditional spinning bicycles are of the single structure, which can no longer meet people's needs for fun fitness and immersive fitness.

### SUMMARY

In view of this, the purpose of the present application is to provide a fitness control system and a spinning bicycle. The central controlling unit detects the change information of fitness equipment parameters, and the terminal device performs controlling and simulates user to move in the fitness scene, and feeds the scene road condition information back to the central controlling unit. The central controlling unit generates corresponding feedback, so that the user can be immersed in the fitness scene, which improves the user's fitness fun and real feeling.

On one aspect, embodiments of the present application provide a fitness control system, applicable to fitness equipment, wherein the fitness control system comprises: a central controlling unit and a terminal device connected to the central controlling unit, the terminal device comprises a display screen, through which a graphical user interface is provided, which displays a target fitness scene, and the target fitness scene contains a virtual character which is used to simulate a user who uses the fitness equipment.

The central controlling unit is configured to detect change information of individual parameters of the fitness equipment in real time during the user is making exercise using the fitness equipment, and send the change information of the individual parameters of the fitness equipment to the terminal device.

The terminal device is configured to control, according to the change information of the individual parameters of the fitness equipment, the virtual character to stimulate movement of the user who uses the fitness equipment in the target fitness scene, and detect in real time, during the virtual character stimulates movement of the user, road condition information in the target fitness scene, wherein when the road condition information meets a set condition, the terminal device feeds back to the central controlling unit a control signal matching the set condition, wherein the control signal is determined according to influence that road condition information matching the set condition makes to the fitness equipment.

The central controlling unit is further configured to receive the control signal matching the set condition, and control, based on the control signal, the fitness equipment to generate a feedback matching the influence.

In a preferable technical solution of the present application, the above fitness equipment comprises a handlebar, the fitness control system further comprises a vibration unit which is installed at the handlebar and electrically connected to the central controlling unit.

The central controlling unit is specifically configured to control the vibration unit to generate a vibration feedback matching the influence at the handlebar of the fitness equipment according to the received control signal.

In a preferable technical solution of the present application, when the above road condition information meets different set conditions, different control signals are fed back correspondingly; the set condition is determined based on bumpiness of a road surface in the target fitness scene; and the bumpiness represents a bumpy degree of the road surface in the target fitness scene.

The control signal corresponds to a vibration frequency and a vibration amplitude, and the bumpiness is positively correlated with the vibration frequency and vibration amplitude corresponding to the control signal.

In a preferable technical solution of the present application, the above fitness equipment comprises wheels, the fitness control system comprises a first angle detection unit, and the first angle detection unit is arranged on the wheel and is electrically connected to the central controlling unit.

The first angle detection unit is configured to detect wheel rotation parameters of the fitness equipment in real time during the user uses the fitness equipment to exercise, and send the wheel rotation parameters to the central controlling unit.

The central controlling unit is configured to obtain, by calculation, wheel rotation change parameters of the fitness equipment according to the received wheel rotation parameters, and send the wheel rotation change parameters of the fitness equipment to the terminal device.

In a preferable technical solution of the present application, the above fitness equipment comprises a handlebar, the fitness control system comprises a second angle detection unit, and the second angle detection unit is installed at the handlebar and is electrically connected to the central controlling unit.

The second angle detection unit is configured to detect handlebar rotation parameters of the fitness equipment in real time during the user uses the fitness equipment to exercise, and send the handlebar rotation parameters to the central controlling unit.

The central controlling unit is configured to obtain, by calculation, handlebar rotation change parameters of the fitness equipment according to the received handlebar rotation parameters, and send the handlebar rotation change parameters of the fitness equipment to the terminal device.

In a preferable technical solution of the present application, the above fitness equipment comprises wheels and the fitness control system further comprises: a speed adjustment unit and a user operation unit respectively electrically connected to the central controlling unit.

The user operation unit is configured to determine a corresponding operation signal, according to a speed adjustment parameter corresponding to a wheel speed adjustment operation, in response to a user's wheel speed adjustment operation for the fitness equipment, and send the operation signal to the central controlling unit.

The central controlling unit is configured to generate, according to the received operation signal, a speed adjustment signal corresponding to the operation signal, and send the speed adjustment signal to the speed adjustment unit.

The speed adjustment unit is configured to adjust a rotation speed of the wheels of the fitness equipment, based on the speed adjustment parameter, according to the received speed adjustment signal.

In a preferable technical solution of the present application, the above user operation unit comprises an up/down gear controlling unit.

The up/down gear controlling unit is configured to determine, according to a up/down gear adjustment parameter corresponding to the up/down gear adjustment operation, a corresponding up/down gear operation signal in response to a user's up/down gear operation for the fitness equipment, and send the up/down gear operation signal to the central controlling unit.

The central controlling unit is configured to generate, according to the received up/down gear operation signal, an acceleration/deceleration signal corresponding to the up/down gear operation signal, and send the acceleration/deceleration signal to the speed adjustment unit.

The speed adjustment unit is configured to adjust a gear position of the fitness equipment, based on the up/down gear adjustment parameter, according to the received acceleration/deceleration signal.

In a preferable technical solution of the present invention, the above user operation unit comprises a brake controlling unit.

The brake controlling unit is configured to determine a brake operation signal in response to a user's brake operation for the fitness equipment, and send the brake operation signal to the central controlling unit.

The central controlling unit is configured to generate a braking signal corresponding to the brake operation signal according to the received brake operation signal, and send the braking signal to the speed adjustment unit.

The speed adjustment unit is configured to control braking of the fitness equipment according to the received braking signal.

In a preferable technical solution of the present application, the above speed adjustment unit comprises a magnetic control unit and an electromagnet, wherein the electromagnet is arranged at the wheel; and the magnetic control unit is electrically connected to the central controlling unit and the electromagnet, respectively.

The central controlling unit is specifically configured to generate a pulse adjustment signal corresponding to the operation signal according to the received operation signal, and send the pulse adjustment signal to the magnetic control unit.

The magnetic control unit is configured to generate, according to the received pulse adjustment signal, an adjustment current corresponding to the pulse adjustment signal, and send the adjustment current to the electromagnet.

The electromagnet is configured to generate, according to the received adjustment current, a magnetic force corresponding to the adjustment current, and control rotation speed of the wheels through the generated magnetic force.

On the second aspect, embodiments of the present application provides a spinning bicycle, comprising a bicycle body and the fitness control system mentioned above, wherein the fitness control system is installed on the bicycle body.

In a preferable technical solution of the present application, the above bicycle body comprises a frame, a handlebar, and wheels, wherein the vibration unit is arranged on the handlebar; the first angle detection unit is arranged on the wheel, the second angle detection unit, for detection, is arranged on the handlebar, the user operation unit is arranged on the handlebar, and the speed adjustment unit is arranged on the wheel.

In a preferable technical solution of the present application, the above bicycle body comprises a frame, a handlebar, and wheels, wherein the central controlling unit is arranged inside the handlebar, and the terminal device is arranged on a front side of the handlebar, the vibration unit is arranged at a grip of the handlebar; the first angle detection unit is arranged at a center of the wheel; the second angle detection unit, for detection, is arranged on a bottom side of the handlebar which is connected with the frame, the magnetic control unit is arranged inside the handlebar, and the electromagnet is arranged on periphery of the wheels.

The technical solutions provided by the embodiments of the present application may have the following beneficial effects.

The fitness control system comprises: a central controlling unit and a terminal device connected to the central controlling unit, the terminal device comprises a display screen, through which a graphical user interface is provided, which displays a target fitness scene and the target fitness scene contains a virtual character which is used to simulate a user who uses the fitness equipment; the central controlling unit is configured to detect change information of individual parameters of the fitness equipment in real time during the user is making exercise using the fitness equipment, and send the change information of the individual parameters of the fitness equipment to the terminal device; the terminal device is configured to control, according to the change information of the individual parameters of the fitness equipment, the virtual character to stimulate movement of the user who uses the fitness equipment in the target fitness scene, and detect in real time, during the virtual character stimulates movement of the user, road condition information in the target fitness scene, wherein when the road condition information meets a set condition, the terminal device feeds back to the central controlling unit a control signal matching the set condition, wherein the control signal is determined according to influence that road condition information matching the set condition makes to the fitness equipment; and the central controlling unit is further configured to receive the control signal matching the set condition, and control, based on the control signal, the fitness equipment to generate a feedback matching the influence.

The central controlling unit of the present application detects the change information of each parameter of the fitness equipment in real time, and sends the parameter change information to the terminal device. The terminal device controls the virtual character to simulate the movement of the user using the fitness equipment in the target fitness scene and sends to the central controlling unit the road condition information in the detected target fitness scene. The central controlling unit will give the user using the fitness equipment the feedback corresponding to the road condition information in the target fitness scene according to the road condition information in the target fitness scene, so that the user feels fun, being immersed in the target fitness scene, so as to improve the user's true feelings in the target fitness scene.

In order to make the above-mentioned objectives, features and advantages of the present application more clear and understandable, the preferred embodiments, in combination with accompanying drawings, are described in detail as follows.

### BRIEF DESCRIPTION OF DRAWINGS

In order to explain the technical solutions of the embodiments of the present application more clearly, the drawings that need to be used in the embodiments will be briefly introduced as follows. It should be understood that the following drawings only show certain embodiments of the present application, and therefore should not be regarded as limitation on the scope. For those ordinarily skilled in the art, without creative work, other related drawings can be obtained from these drawings.

FIG. 1 shows a schematic diagram of a fitness control system provided by an embodiment of the present application;

FIG. 2 shows a schematic diagram of another fitness control system provided by an embodiment of the present application;

FIG. 3 shows a schematic diagram of a speed adjustment unit provided by an embodiment of the present application; and

FIG. 4 is a schematic diagram of a spinning bicycle provided by an embodiment of the present application.

### DETAILED DESCRIPTION OF EMBODIMENTS

In order to make the purpose, technical solutions and advantages of the embodiments of the present application clearer, the technical solutions in the embodiments of the present application will be described clearly and completely in conjunction with the accompanying drawings in the embodiments of the present application. Obviously, the described embodiments are only a part of the embodiments of the present application, but not all of the embodiments. The components of the embodiments of the present application described and shown in the drawings herein may be generally arranged and designed in various different configurations. Therefore, the following detailed description of the embodiments of the present application provided in the accompanying drawings is not intended to limit the claimed scope of the present application, but merely represents selected embodiments of the present application. Based on the embodiments of the present application, all other embodiments obtained by those skilled in the art without creative work shall fall within the protection scope of the present application.

The existing spinning bicycles have a single function, and especially the handlebars are monotonous, which cannot make the user feel in a fitness scene, and the user is prone to be lonely and boring when using it.

Based on this, the embodiments of the present application provide a fitness control system and a spinning bicycle, which are described below by means of embodiments. In the case of no conflict, the following embodiments and features in the embodiments can be combined with each other.

The fitness control system provided by the present application is applicable to fitness equipment. Users use fitness equipment for sports and exercises to achieve the purpose of enhancing their physical fitness. The fitness equipment in the present application comprises handlebar and wheels. The user holds the handlebar when using the fitness equipment.

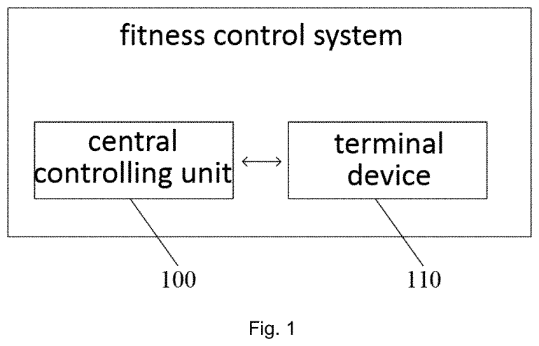

FIG. 1 shows a fitness control system provided by an embodiment of the present application. The fitness control system comprises: a central controlling unit 100 and a terminal device 110 connected with the central controlling unit 100. The terminal device may be electrically or communicatively connected with the central controlling unit 100. The terminal device 110 comprises a display screen and a graphical user interface is provided by the display screen. A target fitness scene is displayed in the graphical user interface, and the target fitness scene comprises a virtual character for simulating a user using the fitness equipment.

The terminal device 110 is configured to display, in response to a user's selection operation for a fitness scene, on the graphical user interface, the target fitness scene selected by the user.

The central controlling unit 100 is used to detect the change information of the individual parameters of the fitness equipment in real time during the user is doing exercise using the fitness equipment, and send the change information of the individual parameters of the fitness equipment to the terminal device 110.

The terminal device 110 is used to control the virtual character to simulate the movement of the user using the fitness equipment in the target fitness scene according to the change information of the individual parameters of the fitness equipment; and to detect the road condition information of the target fitness scene in real time while the virtual character is simulating the movement of the user. When the road condition information satisfies the set condition, it feedbacks to the central controlling unit 100 a control signal matching the set condition, wherein the control signal is determined according to the influence which the road condition information matching the set condition makes to the fitness equipment.

The central controlling unit 100 is also used to receive a control signal matching the set condition, and control the fitness equipment to generate a feedback matching the influence according to the control signal.

When using this system, the terminal device 110 initially displays a default fitness scene, and the fitness scene comprises a virtual character for simulating a user using the fitness equipment. The user can select one target fitness scene through the terminal device 110 according to his/her own preferences, and at this time, the virtual character simulating the user who uses the fitness equipment will be in the target fitness scene.

During the user is using the fitness equipment to exercise, the components of the fitness equipment move along with the user's fitness actions, that is, the parameters of the fitness equipment will change. For example, when the user is exercising, the wheels of the fitness equipment will rotate along with the user's fitness actions. Assuming that the initial angle of the wheel is 0°, when the user is exercising, the wheel rotates clockwise by 10°, and the parameter change information of the fitness equipment is +10°. The central controlling unit 100 detects the change information of individual parameters of the fitness equipment in real time, and sends the detected change information of the individual parameters of the fitness equipment to the terminal device 110, so as to provide data support to the terminal device 110 for updating the movement of the virtual character.

The terminal device 110 controls the virtual character in the target fitness scene to make changes corresponding to the parameter change information of the fitness equipment according to the parameter change information of the fitness equipment provided by the central controlling unit 100, that is, the terminal device 110 communicates with the central controlling unit 100, so that the virtual character of the user in the target fitness scene is synchronized with the fitness action of the actual user.

When the terminal device 110 controls the virtual character to simulate the movement of the user using the fitness equipment in the target fitness scene, the road conditions in the target fitness scene are also constantly changing, and the terminal device 110 detects the road condition information in the target fitness scene in real time. When the road condition information meets the set conditions, the terminal device 110 feeds back a control signal matching the set condition to the central controlling unit 100 according to the detected road condition information. The central controlling unit 100 controls the fitness equipment to generate corresponding feedback according to the control signal.

For example, the target fitness scene is a bumpy gravel road. The terminal device 110, according to the detected bumpy degree of the gravel road, sends a bump control signal to the central controlling unit 100, when the bumpy degree is greater than a preset threshold. The central controlling unit 100 controls the handlebar of the fitness equipment to vibrate.

The present application provides a target fitness scene for the user through the terminal device 110, which improves the interest of the user during fitness. The central controlling unit 100 communicates with the terminal device 110 so that the user can see in real time his/her own movement in the target fitness scene when using the fitness equipment to exercise, and can experience the road conditions in the target fitness scene, so that users can perform the immersive fitness.

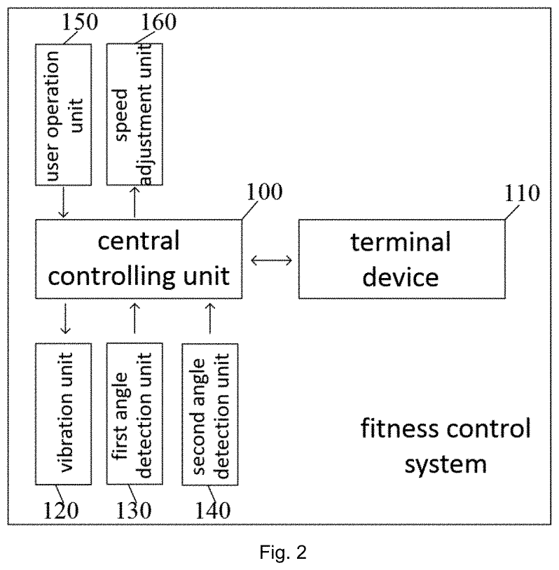

As shown in FIG. 2, in the embodiment of the present application, as an optional embodiment, the fitness control system further comprises a vibration unit 120, which is installed at the handlebar and is electrically connected to the central controlling unit 100.

The central controlling unit 100 is specifically configured to control the vibration unit 120 to generate a vibration feedback matching the influence, at the handlebar of the fitness equipment, according to the received control signal.

When the road condition information meets different set conditions, different control signals are correspondingly fed back. The set conditions are determined according to the bumpiness of the road in the target fitness scene. The bumpiness represents the bumpy degree of the road in the target fitness scene.

The control signal corresponds to the vibration frequency and the vibration amplitude, and the bumpiness is positively correlated with the vibration frequency and vibration amplitude corresponding to the control signal.

Specifically, the fitness control system of the present application comprises a vibration unit 120. The vibration unit 120 generates the vibration frequency and the vibration amplitude corresponding to the bumpy degree, according to the bumpy degree of the road in the fitness scene. That is, the higher the bumpy degree is, the greater the vibration frequency and the vibration amplitude corresponding to the control signal generated by the central controlling unit 100 are. The vibration unit 120 generates the corresponding vibration frequency and vibration amplitude.

For example, there is a stone on the road surface of the target fitness scene. The virtual character overwhelms the stone in the target fitness scene, and one bump occurs. The terminal device 110 sends to the central controlling unit 100 the information that the stone has been detected in the target fitness scene. The central controlling unit 100 feeds back a control signal corresponding to the vibration frequency and the amplitude of the stone information, and the vibration unit 120 generates corresponding vibration according to the control signal. Thus, in the process of using the fitness equipment to exercise, the user can not only see the target fitness scene, but also truly experience the road condition in the target fitness scene.

In the embodiment of the present application, as an optional embodiment, the fitness control system comprises a first angle detection unit 130, and the first angle detection unit 130 is arranged on the wheel and is electrically connected to the central controlling unit 100.

The first angle detection unit 130 is used to detect the wheel rotation parameters of the fitness equipment in real time during the user is using the fitness equipment to exercise, and send the wheel rotation parameters to the central controlling unit 100.

The central controlling unit 100 is configured to calculate the wheel rotation change parameters of the fitness equipment according to the received wheel rotation parameters, and send the wheel rotation change parameters of the fitness equipment to the terminal device 110.

The central controlling unit 100 of the present application detects the change information of individual parameters of the fitness equipment, specifically, the wheel rotation parameters are real-time detected through the first angle detection unit 130, the first angle detection unit 130 sends the detected multiple wheel rotation parameters to the central controlling unit 100. The central controlling unit 100 calculates the wheel rotation change parameters according to the multiple received wheel rotation parameters.

The first angle detection unit 130 detects the first wheel rotation parameter and the second wheel rotation parameter, and sends the first wheel rotation parameter and the second wheel rotation parameter to the central controlling unit 100, which obtains, based on the first wheel rotation parameter and the second wheel rotation parameter, the wheel rotation change parameters.

For example, the first angle detection unit 130 detects that the wheel rotates by 5° clockwise, and the first wheel rotation parameter is +5°; the first angle detection unit 130 then detects that the wheel rotates by 3° clockwise, and the second wheel rotation parameter is +3°; and then the wheel rotation change parameter is +8°.

The first angle detection unit 130 detects that the wheel rotates by 5° clockwise, and the first wheel rotation parameter is +5°; the first angle detection unit 130 then detects that the wheel rotates by 3° counterclockwise, and the second wheel rotation parameter is −3°; and then the wheel rotation change parameter is +2°.

In the embodiment of the present application, as an optional embodiment, the fitness control system comprises a second angle detection unit 140; and the second angle detection unit 140 is installed at the handlebar and is electrically connected to the central controlling unit 100.

The second angle detection unit 140 is used to detect the handlebar rotation parameters of the fitness equipment in real time during the user is using the fitness equipment to exercise, and send the handlebar rotation parameters to the central controlling unit 100.

The central controlling unit 100 is configured to calculate the handlebar rotation change parameters of the fitness equipment according to the received handlebar rotation parameters, and send the handlebar rotation change parameters of the fitness equipment to the terminal device 110.

The handlebar of the fitness equipment in the present application is in a rotatable state. The central controlling unit 100 of the present application detects the change information of individual parameters of the fitness equipment, specifically, the second angle detection unit 140 is installed at the handlebar, and the handlebar rotation parameters are detected. The second angle detection unit 140 sends the multiple detected handlebar rotation parameters to the central controlling unit 100, and the central controlling unit 100 calculates the handlebar rotation change parameters according to the multiple received handlebar rotation parameters.

The second angle detection unit 140 detects the first handlebar rotation parameter and the second handlebar rotation parameter, and sends the first handlebar rotation parameter and the second handlebar rotation parameter to the central controlling unit 100, which obtains, based on the first handlebar rotation parameter and the second handlebar rotation parameter, the handlebar rotation change parameters.

For example, the second angle detection unit 140 detects that the handlebar turns by 2° to the right, and the first handlebar rotation parameter is +2°; and the second angle detection unit 140 then detects that the handlebar turns by 1° to the right, and the second handlebar rotation parameter is +1′; and then the handlebar rotation change parameter is +3°.

The second angle detection unit 140 detects that the handlebar rotates by 2° to the right, and the first handlebar rotation parameter is +2°; and the second angle detection unit 140 then detects that the handlebar rotates by 1° to the left, and the second handlebar rotation parameter is −1°; and then the handlebar rotation change parameter is +1°.

In the embodiment of the present application, as an optional embodiment, the fitness control system further comprises: a speed adjustment unit 160 and a user operation unit 150 that are respectively electrically connected to the central controlling unit 100.

The user operation unit 150 is used to determine, in response to the user's wheel speed adjustment operation for the fitness equipment, the corresponding operation signal, according to the speed adjustment parameter corresponding to the wheel speed adjustment operation, and send the operation signal to the central controlling unit 100.

The central controlling unit 100 is configured to generate a speed adjustment signal corresponding to the operation signal according to the received operation signal, and send the speed adjustment signal to the speed adjustment unit 160.

The speed adjustment unit 160 is configured to adjust the rotation speed of the wheels of the fitness equipment, based on the speed adjustment parameter, according to the received speed adjustment signal.

In the embodiment of the present application, as an optional embodiment, the user operation unit 150 comprises an up/down gear controlling unit.

The up/down gear controlling unit is used to determine, in response to the user's up/down gear operation for the fitness equipment, the corresponding up/down gear operation signal, according to the up/down gear adjustment parameter corresponding to the up/down gear adjustment operation, and send the up/down gear operation signal to central controlling unit 100.

The central controlling unit 100 is configured to generate an acceleration/deceleration signal corresponding to the up/down gear operation signal according to the received up/down gear operation signal, and send the acceleration/deceleration signal to the speed adjustment unit 160.

The speed adjustment unit 160 is configured to adjust the gear position of the fitness equipment, based on the received acceleration/deceleration signal, according to the up/down gear adjustment parameter.

In the embodiment of the present application, as an optional embodiment, the user operation unit 150 comprises a brake controlling unit.

The brake controlling unit is used to determine, in response to the brake operation of the user for fitness equipment, the brake operation signal, and send the brake operation signal to the central controlling unit 100.

The central controlling unit 100 is used to generate the braking signal corresponding to the brake operation signal, according to the received brake operation signal, and send the braking signal to the speed adjustment unit 160.

The speed adjustment unit 160 is used to control the braking of the fitness equipment according to the received braking signal.

The fitness control system comprises a user operation unit 150, which is arranged at the handlebar, which is convenient for the user to operate. During the fitness process, the user can select the desired gear position or brake operation through the user operation unit 150 according to the target fitness scene.

The user operation unit 150, in response to the user's wheel speed adjustment operation for the fitness equipment, generates an operation signal corresponding to the user's speed adjustment operation, and sends the operation signal to the central controlling unit 100. The central controlling unit 100 generates a corresponding speed adjustment signal according to the operation signal. The speed adjustment unit adjusts the rotation speed of the wheels according to the speed adjustment signal.

For example, the user is using the third gear to exercise, the magnetic force received by the wheels in the third gear is 4N, and the magnetic force received by the wheels in the fourth gear is 3N. The user inputs the “increasing one gear” operation through the user operation unit (control button). The user operation unit sends to the central controlling unit 100 an operation signal for increasing one gear. The central controlling unit 100 generates the speed adjustment signal for reducing the received force to 3N, according to the received operation signal of increasing one gear, and sends to the speed adjustment unit 160 the generated speed adjustment signal of reducing the received force to 3N, and the speed adjustment unit 160 adjusts the rotation speed of the wheels to 3N.

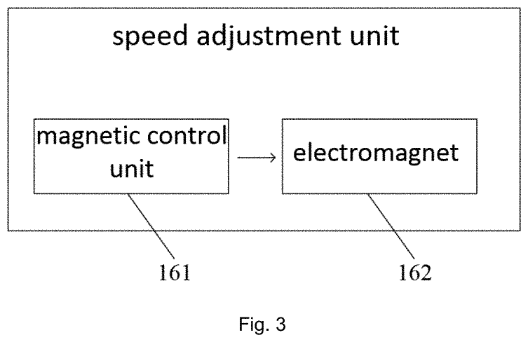

As shown in FIG. 3, the speed adjustment unit 160 comprises a magnetic control unit 161 and an electromagnet 162. The electromagnet 162 is arranged at the wheel. The magnetic control unit 161 is electrically connected to the central controlling unit 100 and the electromagnet 162, respectively.

The central controlling unit 100 is specifically configured to generate a pulse adjustment signal corresponding to the operation signal according to the received operation signal, and send the pulse adjustment signal to the magnetic control unit 161.

The magnetic control unit 161 generates an adjustment current corresponding to the pulse adjustment signal according to the received pulse adjustment signal, and sends the adjustment current to the electromagnet 162.

The electromagnet 162 generates a magnetic force corresponding to the adjustment current according to the received adjustment current, and controls the rotation speed of the wheel through the generated magnetic force.

The speed adjustment unit 160 of this fitness control system is specifically a magnetic control unit 161 and an electromagnet 162. The central controlling unit 100 controls the magnetic control unit 161 through the pulse adjustment signal. The magnetic control unit 161 generates an adjustment current corresponding to the pulse adjustment signal. The magnetic control unit 161 controls the electromagnet 162 by the adjustment current, and the electromagnet 162 generates the magnetic force corresponding to the adjustment current. The wheel rotation speed is related to the magnetic force. The greater the magnetic force is, the lower the wheel rotation speed is. The smaller the magnetic force is, the greater the wheel rotation speed is. When the user performs a braking operation, the electromagnet 162 attracts the wheels, so that the wheels stop the rotation.

In the embodiments of the present application, as an optional embodiment, a spinning bicycle comprises a bicycle body and the above-mentioned fitness control system; and the fitness control system is installed on the bicycle body.

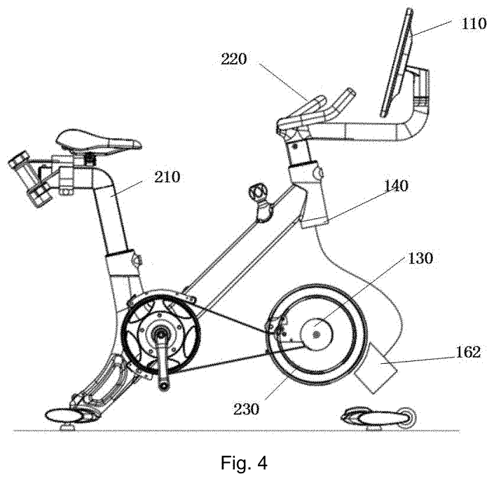

As shown in FIG. 4, the bicycle body comprises a frame 210, a handlebar 220, and wheels 230. The vibration unit 120 is arranged on the handlebar 220; and the first angle detection unit 130 is arranged on the wheels 230, and the second angle detection unit 140, for detection, is arranged on the handlebar 220, the user operation unit 150 is arranged on the handlebar 220, and the speed adjustment unit 160 is arranged on the wheels 230.

Specifically, the central controlling unit 100 is arranged inside the handlebar 220, the terminal device 110 is arranged on the front side of the handlebar 220, and the vibration unit 120 is arranged at the grip of the handlebar 220. The first angle detection unit 130 is arranged at the center of the wheel 230. The second angle detection unit 140, for detection, is arranged at the bottom side of the handlebar 220 in connection with the frame 210, the magnetic control unit 161 is arranged inside the handlebar 220, and the electromagnet 162 is arranged on the periphery of the wheel 230. In this spinning bicycle, the frame 210 is movably connected with the handlebar 220, that is, the handlebar 220 can be rotated to the left and right. The terminal device 110 may be a tablet computer. The frame 210 is provided with other components necessary for a spinning bicycle, such as a seat and a pedal.

When using the spinning bicycle, the user turns on the tablet computer, and the tablet computer will display a default fitness scene. The fitness scene comprises a virtual character that simulates the user who uses the spinning bicycle. The user can select through the tablet computer a favorite target fitness scene, so that the virtual character used to simulate the user who uses the spinning bicycle is in the target fitness scene. When the user uses the spinning bicycle, the virtual character also moves correspondingly in the target fitness scene, and at the same time, when there is a bumpy road section in the target fitness scene, the central controlling unit 100 gives the user a same bumpy experience as the target fitness scene through the vibration unit 120. When the user uses the spinning bicycle to perform the turning, gear shifting or braking, the virtual character also performs the corresponding operations, so that the user can immerse in the target fitness scene for fitness.

Specifically, currently, as for almost all of the spinning bicycles, when detecting cadence (that is, the rotation of the wheel 230), the central controlling unit 100 can detect the user's pedaling action only when the user performs the pedaling for one circle (that is, the wheel 230 rotates by 360°), which cannot reflect the real actions of the user.

This spinning bicycle adopts a reed switch, a permanent magnet, and the first angle sensor, which increases the detection path. When the wheel rotates, the first angle sensor generates angle change data, which is transmitted to the central controlling unit 100 through the SPI interface, to complete the cadence detection.

When the user is riding, the first angle sensor detects the rotation angle of the wheel 230 while the user is pedaling, and sends the detected rotation angle information of the wheel 230 to the central controlling unit 100, and the central controlling unit 100 will calculate the rotation angle change information of the wheel 230 according to the rotation angle information of the wheel 230, and transmit it to the tablet computer via Bluetooth. After the tablet computer receives the rotation angle change information of the wheel 230, the target fitness scene is controlled to change accordingly. In this way, the actual pedaling speed of the user can be synchronized with the virtual character in the target fitness scene on the tablet computer, so that the user can experience the target fitness scene in an immersive manner.

In order to improve the user's real experience, this spinning bicycle is provided with a movable handlebar 220 to improve the playability.

A second angle sensor is arranged inside the handlebar 220, and the rotation information of the handlebar 220 is transmitted to the central controlling unit 100 through the SPI interface. When the handlebar 220 rotates, the second angle sensor transmits the rotation information to the central controlling unit 100, and the central controlling unit 100 obtains the rotation change information of the handlebar 220 according to the rotation information of the handlebar 220. When the user rides to the target fitness scene and needs to make turn, it is possible to control the handlebar 220 to turn. When the handlebar 220 turns to the left or right, the second angle sensor in the handlebar 220 will detect the rotation angle data of the handlebar 220, and transmit the rotation angle data of the handlebar 220 to the central controlling unit 100. After receiving the rotation angle data of the handlebar 220, the central controlling unit 100 transmits the data of being required to turn left or right, to the tablet computer via Bluetooth, and the tablet computer controls the bicycle and the virtual character in the target fitness scene to make turn. The turning of the bicycle and the virtual character here is not a direct turning left or right, but a rotation of corresponding degrees according to the rotation change angle of the handlebar 220.

The central controlling unit 100 collects the current information of the magnetic control unit 161 through the 120 bus, the central controlling unit 100 collects the current change of the magnetic control unit 161, and the central controlling unit 100 performs the current control on the magnetic control unit 161 by adjusting the PWM input.

When braking is needed during riding, the user presses the brake controlling unit (brake button). The brake controlling unit receives the brake signal and then transmits it to the central controlling unit 100 via the 485 bus. The central controlling unit 100 receives the brake information and will adjust the PWM and output it to the magnetic control unit 161, and the magnetic control unit 161 increases the magnetic force to stop the rotation of the wheels 230 of the spinning bicycle, and at the same time, the virtual character in the target fitness scene on the tablet computer will stop accordingly.

This spinning bicycle, by means of the up/down gear switch on the handlebar 220, sends an up/down gear signal to the central controlling unit 100. The up/down gear signal is processed by the central controlling unit 100, and the central controlling unit 100 transmits the processed up/down gear information to the magnetic control unit 161, the magnetic control unit 161 realizes the switching between the high and low gears by increasing or decreasing the current, and the gear switching is displayed on the tablet computer. For example, when riding from a flat road to an uphill section, considering that the gear position on the flat road is Gear 4, if using Gear 4 to climb and ride, more pedaling force will be used, while when the gear position is lowered, a lot of effort will be saved during riding, so that the user can achieve a real riding experience.

In this spinning bicycle, the left and right vibration function of the handlebar 220 is added to the handlebar 220. When the virtual character rides on the bumpy road in the target fitness scene on the tablet computer, the bumpy road information is returned to the central controlling unit 100. The central controlling unit 100, after receiving the bumpy road information, will send a vibration signal to a motor driving part. After receiving the signal, the motor driving part drives the left and right vibration motors on the handlebar 220 to perform vibration.

In the embodiments provided in the present application, it should be understood that the disclosed system and method may be implemented in other ways. The system embodiments described above are merely illustrative. For example, the division of the units is only a logical function division, and there may be other division modes in actual implementation. For example, multiple units or components may be combined or can be integrated into another system, or some features can be ignored or not implemented. In addition, the shown or discussed mutual coupling or direct coupling or communication connection may be the indirect coupling or communication connection via some communication interfaces, systems or units, and may be in electrical form, mechanical form or other forms.

The units described as separate components may or may not be physically separated, and the components displayed as a unit may or may not be a physical unit, that is, they may be located in one place, or they may be distributed on multiple network units. Some or all of the units may be selected according to actual needs to achieve the objectives of the technical solutions of the embodiments.

In addition, the functional units in the embodiments provided in the present application may be integrated into one processing unit, or each unit may exist alone physically, or two or more units may be integrated into one unit.

If the function is implemented in the form of a software functional unit and sold or used as an independent product, it can be stored in a computer readable storage medium. Based on this understanding, the technical solution of the present application can be essentially embodied in the form of a software product, or a part thereof that contributes to the existing technology can be embodied in the form of a software product, or the part of the technical solution can be embodied in the form of a software product. The computer software product is stored in a storage medium, including plural instructions which are used to make a computer device (which may be a personal computer, a server, or a network device, etc.) execute all or part of the steps of the methods described in the individual embodiments of the present application. The aforementioned storage media comprise: U disk, mobile hard disk, read-only memory (ROM), random access memory (RAM), magnetic disks or optical disks and other media that can store program codes.

It should be noted that similar reference numbers and letters indicate similar items in the following drawings. Therefore, once an item is defined in one drawing, it is not needed to be further defined and explained in subsequent drawings. In addition, the terms “first”, “second”, “third”, etc. are only used for distinguishing description, and cannot be understood as indicating or implying relative importance.

Finally, it should be noted that the above-mentioned embodiments are only specific implementations of the present application, which are used to illustrate the technical solutions of the present application, rather than limit it. The scope of protection of the present application is not limited to this. Although referring to the foregoing embodiments to describe the present application in detail, those ordinarily skilled in the art should understand that any person skilled in the art can still modify the technical solutions described in the foregoing embodiments within the technical scope disclosed in the present application, or changes may be easily conceived of, or some of the technical features thereof may be equivalently replaced. These modifications, changes or replacements do not cause the corresponding technical solutions to essentially deviate from the spirit and scope of the technical solutions of the embodiments of the present application. All should be covered within the scope of protection of the present application. Therefore, the protection scope of the present application shall be defined by the claims.

What is claimed is:

1. A fitness control system, applicable to fitness equipment, wherein the fitness control system comprises: a central controlling unit and a terminal device connected to the central controlling unit, wherein the terminal device comprises a display screen, through which a graphical user interface is provided, wherein the graphical user interface displays a target fitness scene and the target fitness scene contains a virtual character which is used to simulate a user who uses the fitness equipment;
the central controlling unit is configured to detect change information of individual parameters of the fitness equipment in real time during the user is making exercise using the fitness equipment, and send the change information of the individual parameters of the fitness equipment to the terminal device;
the terminal device is configured to control, according to the change information of the individual parameters of the fitness equipment, the virtual character to stimulate movement of the user who uses the fitness equipment in the target fitness scene, and detect in real time, during the virtual character stimulates movement of the user, road condition information in the target fitness scene, wherein when the road condition information meets a set condition, the terminal device feeds back to the central controlling unit a control signal matching the set condition, wherein the control signal is determined according to influence that road condition information matching the set condition makes to the fitness equipment; and
the central controlling unit is further configured to receive the control signal matching the set condition, and control, based on the control signal, the fitness equipment to generate a feedback matching the influence.

2. The fitness control system according to claim 1, wherein the fitness equipment comprises a handlebar, the fitness control system further comprises a vibration unit which is installed at the handlebar and electrically connected to the central controlling unit; and
the central controlling unit is configured to control the vibration unit to generate a vibration feedback matching the influence at the handlebar of the fitness equipment according to a received control signal.

3. The fitness control system according to claim 1, wherein when the road condition information meets different set conditions, different control signals are fed back correspondingly; and the set condition is determined based on bumpiness of a road surface in the target fitness scene, wherein the bumpiness represents a bumpy degree of the road surface in the target fitness scene; and
the control signal corresponds to a vibration frequency and a vibration amplitude, and the bumpiness is positively correlated with the vibration frequency and vibration amplitude corresponding to the control signal.

4. The fitness control system according to claim 1, wherein the fitness equipment comprises wheels, the fitness control system comprises a first angle detection unit, wherein the first angle detection unit is arranged on one of the wheels and is electrically connected to the central controlling unit;
the first angle detection unit is configured to detect wheel rotation parameters of the fitness equipment in real time during the user uses the fitness equipment to exercise, and send the wheel rotation parameters to the central controlling unit; and
the central controlling unit is configured to obtain, by calculation, wheel rotation change parameters of the fitness equipment according to received wheel rotation parameters, and send the wheel rotation change parameters of the fitness equipment to the terminal device.

5. The fitness control system according to claim 1, wherein the fitness equipment comprises a handlebar, the fitness control system comprises a second angle detection unit, wherein the second angle detection unit is installed at the handlebar and is electrically connected to the central controlling unit;
the second angle detection unit is configured to detect handlebar rotation parameters of the fitness equipment in real time during the user uses the fitness equipment to exercise, and send the handlebar rotation parameters to the central controlling unit; and
the central controlling unit is configured to obtain, by calculation, handlebar rotation change parameters of the fitness equipment according to received handlebar rotation parameters, and send the handlebar rotation change parameters of the fitness equipment to the terminal device.

6. The fitness control system according to claim 1, wherein the fitness equipment comprises wheels and the fitness control system further comprises: a speed adjustment unit and a user operation unit respectively electrically connected to the central controlling unit, wherein
the user operation unit is configured to determine a corresponding operation signal, according to a speed adjustment parameter corresponding to a wheel speed adjustment operation, in response to the wheel speed adjustment operation of the user for the fitness equipment, and send the operation signal to the central controlling unit;
the central controlling unit is configured to generate, according to a received operation signal, a speed adjustment signal corresponding to the operation signal, and send the speed adjustment signal to the speed adjustment unit; and
the speed adjustment unit is configured to adjust a rotation speed of the wheels of the fitness equipment, based on the speed adjustment parameter, according to a received speed adjustment signal.

7. The fitness control system according to claim 6, wherein the user operation unit comprises an up/down gear controlling unit, wherein
the up/down gear controlling unit is configured to determine, according to a up/down gear adjustment parameter corresponding to an up/down gear adjustment operation, a corresponding up/down gear operation signal in response to an up/down gear operation of the user for the fitness equipment, and send the up/down gear operation signal to the central controlling unit;
the central controlling unit is configured to generate, according to a received up/down gear operation signal, an acceleration/deceleration signal corresponding to the up/down gear operation signal, and send the acceleration/deceleration signal to the speed adjustment unit; and
the speed adjustment unit is configured to adjust a gear position of the fitness equipment, based on the up/down gear adjustment parameter, according to a received acceleration/deceleration signal.

8. The fitness control system according to claim 6, wherein the user operation unit comprises a brake controlling unit, wherein
the brake controlling unit is configured to determine a brake operation signal in response to a brake operation of the user for the fitness equipment, and send the brake operation signal to the central controlling unit;
the central controlling unit is configured to generate a braking signal corresponding to the brake operation signal according to a received brake operation signal, and send the braking signal to the speed adjustment unit; and
the speed adjustment unit is configured to control braking of the fitness equipment according to a received braking signal.

9. The fitness control system according to claim 6, wherein the speed adjustment unit comprises a magnetic control unit and an electromagnet, wherein the electromagnet is arranged at the wheels; and the magnetic control unit is electrically connected to the central controlling unit and the electromagnet, respectively;
the central controlling unit is configured to generate, according to a received operation signal, a pulse adjustment signal corresponding to the operation signal, and send the pulse adjustment signal to the magnetic control unit;
the magnetic control unit is configured to generate, according to a received pulse adjustment signal, an adjustment current corresponding to the pulse adjustment signal, and send the adjustment current to the electromagnet; and
the electromagnet is configured to generate, according to a received adjustment current, a magnetic force corresponding to the adjustment current, and control rotation speed of the wheels through a generated magnetic force.

10. A spinning bicycle, comprising a bicycle body and the fitness control system according to claim 1, wherein the fitness control system is installed on the bicycle body.

11. The spinning bicycle according to claim 10, wherein the bicycle body comprises a frame, a handlebar, and wheels, wherein a vibration unit is arranged on the handlebar; and a first angle detection unit is arranged on one of the wheels, a second angle detection unit, for detection, is arranged on the handlebar, a user operation unit is arranged on the handlebar, and a speed adjustment unit is arranged on one of the wheels.

12. The spinning bicycle according to claim 10, wherein the bicycle body comprises a frame, a handlebar, and wheels, wherein the central controlling unit is arranged inside the handlebar, and the terminal device is arranged on a front side of the handlebar, a vibration unit is arranged at a grip of the handlebar; a first angle detection unit is arranged at a center of one of the wheels; and a second angle detection unit, for detection, is arranged on a bottom side of the handlebar which is connected with the frame, a magnetic control unit is arranged inside the handlebar, and an electromagnet is arranged on periphery of the wheels.

13. The spinning bicycle according to claim 10, wherein the fitness equipment comprises a handlebar, the fitness control system further comprises a vibration unit which is installed at the handlebar and electrically connected to the central controlling unit; and
the central controlling unit is configured to control the vibration unit to generate a vibration feedback matching the influence at the handlebar of the fitness equipment according to a received control signal.

14. The spinning bicycle according to claim 10, wherein when the road condition information meets different set conditions, different control signals are fed back correspondingly; and the set condition is determined based on bumpiness of a road surface in the target fitness scene, wherein the bumpiness represents a bumpy degree of the road surface in the target fitness scene; and
the control signal corresponds to a vibration frequency and a vibration amplitude, and the bumpiness is positively correlated with the vibration frequency and vibration amplitude corresponding to the control signal.

15. The spinning bicycle according to claim 10, wherein the fitness equipment comprises wheels, the fitness control system comprises a first angle detection unit, wherein the first angle detection unit is arranged on one of the wheels and is electrically connected to the central controlling unit;
the first angle detection unit is configured to detect wheel rotation parameters of the fitness equipment in real time during the user uses the fitness equipment to exercise, and send the wheel rotation parameters to the central controlling unit; and
the central controlling unit is configured to obtain, by calculation, wheel rotation change parameters of the fitness equipment according to received wheel rotation parameters, and send the wheel rotation change parameters of the fitness equipment to the terminal device.

16. The spinning bicycle according to claim 10, wherein the fitness equipment comprises a handlebar, the fitness control system comprises a second angle detection unit, wherein the second angle detection unit is installed at the handlebar and is electrically connected to the central controlling unit;
the second angle detection unit is configured to detect handlebar rotation parameters of the fitness equipment in real time during the user uses the fitness equipment to exercise, and send the handlebar rotation parameters to the central controlling unit; and
the central controlling unit is configured to obtain, by calculation, handlebar rotation change parameters of the fitness equipment according to received handlebar rotation parameters, and send the handlebar rotation change parameters of the fitness equipment to the terminal device.

17. The spinning bicycle according to claim 10, wherein the fitness equipment comprises wheels and the fitness control system further comprises: a speed adjustment unit and a user operation unit respectively electrically connected to the central controlling unit, wherein
the user operation unit is configured to determine a corresponding operation signal, according to a speed adjustment parameter corresponding to a wheel speed adjustment operation, in response to the wheel speed adjustment operation of the user for the fitness equipment, and send the operation signal to the central controlling unit;
the central controlling unit is configured to generate, according to a received operation signal, a speed adjustment signal corresponding to the operation signal, and send the speed adjustment signal to the speed adjustment unit; and
the speed adjustment unit is configured to adjust a rotation speed of the wheels of the fitness equipment, based on the speed adjustment parameter, according to a received speed adjustment signal.

18. The spinning bicycle according to claim 17, wherein the user operation unit comprises an up/down gear controlling unit, wherein
the up/down gear controlling unit is configured to determine, according to a up/down gear adjustment parameter corresponding to an up/down gear adjustment operation, a corresponding up/down gear operation signal in response to an up/down gear operation of the user for the fitness equipment, and send the up/down gear operation signal to the central controlling unit;
the central controlling unit is configured to generate, according to a received up/down gear operation signal, an acceleration/deceleration signal corresponding to the up/down gear operation signal, and send the acceleration/deceleration signal to the speed adjustment unit; and
the speed adjustment unit is configured to adjust a gear position of the fitness equipment, based on the up/down gear adjustment parameter, according to a received acceleration/deceleration signal.

19. The spinning bicycle according to claim 17, wherein the user operation unit comprises a brake controlling unit, wherein
the brake controlling unit is configured to determine a brake operation signal in response to a brake operation of the user for the fitness equipment, and send the brake operation signal to the central controlling unit;
the central controlling unit is configured to generate a braking signal corresponding to the brake operation signal according to a received brake operation signal, and send the braking signal to the speed adjustment unit; and
the speed adjustment unit is configured to control braking of the fitness equipment according to a received braking signal.

20. The spinning bicycle according to claim 17, wherein the speed adjustment unit comprises a magnetic control unit and an electromagnet, wherein the electromagnet is arranged at the wheels; and the magnetic control unit is electrically connected to the central controlling unit and the electromagnet, respectively;
the central controlling unit is configured to generate, according to a received operation signal, a pulse adjustment signal corresponding to the operation signal, and send the pulse adjustment signal to the magnetic control unit;
the magnetic control unit is configured to generate, according to a received pulse adjustment signal, an adjustment current corresponding to the pulse adjustment signal, and send the adjustment current to the electromagnet; and
the electromagnet is configured to generate, according to a received adjustment current, a magnetic force corresponding to the adjustment current, and control rotation speed of the wheels through a generated magnetic force.
